(19) United States
(12) Patent Application Publication
(10) Pub. No.: US 2005/0154677 A1
(43) Pub. Date: Jul. 14, 2005

(54) Process and apparatus for providing markings on security papers

(76) Inventor: Fausto Giori, Lausanne (CH)

Correspondence Address: Clifford W Browning, 111 Mounment Circle Bank One Center/Tower, Suite 3700, Indianapolis, IN, 46204-5137, US

(21) Appl. No.: 10/513,194

(22) PCT Filed: May 23, 2003
(86) PCT No.: PCT/CH03/00331

(30) Foreign Application Priority Data
May 24, 2002 (EP) 02405417.3

(51) Int. Cl. G06F 17/60

(52) U.S. Cl. 705/50

(57) ABSTRACT

Processing unit (8) collects information from reader (7) detecting the guide marks (4) in form of a code bar on the successive sheets (1) led to drum (3) on table (2). It is programmed to send control signals to all the members (51, 52, 53, 61, 62, 63) of two or more marking devices functioning with different printing technologies and to create an authenticating data base. Device (5) functions with a mechanical typography system.

The present invention belongs to the field of the processes and apparatus intended to provide security papers with variable data, each security paper having an individualized identity marking offering improved security against copies or falsification. The term <<security paper >> designates here primarily banknotes, but also designates documents of any kind having financial value, like cheques, lottery tickets, title deeds, and the like. This list is not limitative. The term “identity marking” designates here any sign, readable either by the human eye or solely by a specific machine, whose characteristics may be stored in a file and varied such that each security paper may thereby be distinguished from any other security paper of the same type. Identity makings include, as examples, but are not limited to, serial numbers, code-bars, geometrical sequences, punchings, magnetically encoded zones, and the like.

The present invention concerns more specifically a process for providing composite identity markings on security papers, wherein each composite identity marking comprises a first sequentially distributed alphanumerical identity marking and at least one second identity marking, wherein said first and said at least one second identity markings are linked by a determining rule, wherein said first identity marking is provided by a first marking station and wherein said second identity marking is provided by a second marking station and wherein said first and second marking stations make use of the same or different marking techniques, wherein sets of said security papers are brought successively into marking relationship with said first and second marking stations.

It is already known practice to create security zones on security paper, and in particular on banknotes, by applying images in the form of a film, label or ribbon, so as to make these papers difficult to falsify, particularly to reproduce by the use of photocopiers, the reproduction of quality of which is ever increasing. These images are often optically variable images comprising either a kinegram or a hologram, which has the property of changing appearance, depending on the angle from which they are viewed. These images may be applied either by hot or cold sealing. Machines for applying such images onto otherwise printed banknote sheets are for example described by EP 0625466 or U.S. Pat. No. 6,263,790 or U.S. Pat. No. 6,302,016. Whereas falsifications by means of simple color photocopiers are thereby no longer possible, the affixing of such images does not eliminate falsifications by forgers capable to produce holograms and the like.

Frequently, the identity marking of a security paper comprises a serial number printed on the document. In order to improve the security effect of the usual serial numbers, EP 0768189 teaches to associate, by means of a process as defined above, an additional security feature to the serial number, in the form of an image on a foil, permanently attached to the security paper, wherein the image information is different for each security paper. According to the process taught by EP 0768189, the image information of the foil or label is read, after the fixing step of the foil onto the security paper, by a reading device. The reading device commands a printer, which prints the same information at another place of the security paper, for example in association with the serial number. The identity marking become thus a composite marking, the reproduction or copy of which is more difficult than with the usual serial number alone or with the serial number associated to a hologram image which does not change from paper to paper. This known proposal, however is not quite satisfactory, since a forger, which is capable to imprint an information on a foil, ribbon or label, for example as a group of alphanumerical characters, is also capable to reproduce the same serial of alphanumerical characters elsewhere on a security paper, considering in particular that in the field of forgery, the hourly production rate of false security paper may be slower than in the official production plants of monetary administrations.

Document FR 2733457 teaches to generate for each security paper a randomly generated sequence of at least nine signs, which is printed in addition to the serial number onto the security paper. The series of binomial informations, namely [serial number, random sequence of nine signs] is stored, forming an authenticating database for later authenticating purposes.

WO 01/33514 teaches to provide a security paper firstly with a coded information, which is preferably not visible or at least not readable by the human eye; thereafter, to read the coded information affixed onto the security paper by a specific reading device and to store this information in a database; then to provide the paper with a visible serial number and to store also the serial number in the database. Thus, both informations are binomially stored and may be used later for authentication purposes.

FR 2698985 offers a printing and processing method to secure cheques, using a symbol or number derived from a visible random marking via a code known only to the authorised user. The symbol or number is covered with a removable layer, and said layer can not be removed without being definitively destroyed. Upon executing the check, the user must draw the hidden symbol or number elsewhere, so that the receiving person may check, upon removing the removable layer, that the user is the authorised user. This method authenticates the user and not the security paper itself, since it can not be put in practice without the presence of the authorised user himself.

EP 0737572 discloses a bar code printing system comprising one or more inkjet or laser printers for printing the bar code for positioned radially relative to a sheet feed drum. The end of the printed sheet is held in contact with the sheet feed drum via a series of grippers and suction heads for improving the quality of the marking. This document does not deal with any authenticating aspect of this marking in relation with other printing fields of the sheet.

The aforementioned processes and machines necessitate a reading device for reading and storing the coded information. Thus, they are limited in the variety of information usable as an identity marking. Furthermore, they only integrate this information as a data for subsequent authentication purposes and not as an operating parameter in the framework of the manufacturing process itself.

Therefore the aim of the present invention is to create a process and an apparatus, permitting to produce security papers provided with an improved composite identity marking, with a greater variety of the partial identity markings associated with the serial number of the security paper.

These aims are achieved by a process and an apparatus, wherein said first and second marking stations are controlled by a common processing unit using an authenticating database, said authenticating database associating to each said first alphanumerical identity marking one said second identity marking, and wherein said processing unit issues sequentially ordered control signals to said first and second marking stations, such that each of said stations achieves on each of the security papers sequentially determined markings, able to form with the markings achieved on the same security paper by the other station(s) a composite marking, wherein said second marking and said first marking correspond together by virtue of said rule.

The process may provide a third identity marking, or even more, controlled by the same processing unit in the same way as the second marking.

Thus, contrarily to the aforementioned processes of the prior art, wherein the identity markings are merely recorded for future authentication purposes, in the process according to the present invention, the first identity marking is used to generate one or several further identity markings.

Preferably, the first, the second and eventually following marking stations make use of different marking techniques. By way of example, the first identity marking may be achieved by means of a mechanical typography process. The alphanumerical characters may be realized by a set of electromechanical numbering boxes known in the art, wherein the characters selected for each print are controlled by the processing unit. The second identity marking may comprise the same alphanumerical signs as the first identity marking at different locations of the security paper and affixed by different printing techniques.

Preferably, for rendering falsification more difficult, the second and the following identity markings should not exhibit the same visible signs as the first identity marking. The second identity marking may be performed for example with non-visible ink. The second marking may materialize a data calculated from the first identity marking by means of a mathematical or otherwise logical rule.

For avoiding that forgers could be able to find the aforesaid mathematical/logical rule, the data which shall be materialized into a second identity marking may be a randomly generated data, each one of said data being recorded in the authenticating data base in association with a corresponding first identity marking.

When the sets of security papers are assemblies in form of sheets, where the individual security papers occupy adjacent fields distributed in rows and columns, preferably each marking station comprises a plurality of component marking devices, the operating zone of each marking device corresponding to one column, and the control signals emitted by the processing unit are distributed to the different component marking devices, the signals received by each component marking device being sequentially elaborated by means of the authenticating data base in function of the location of the component marking device.

According to a preferred embodiment of the invention, the processing unit is coupled to a device detecting and recording misprints on the sheets of security papers already imprinted with a base design. The guiding mark is associated to each sheet and to a record of the misprints of said sheet, so as to form a transient database; this transient database is combined with the authenticating database by the processing unit, so that the control signals emitted by this processing unit skip achievement of an identity marking by the components of the marking devices on those fields where misprints of the base design have been detected. The misprints either receive no identity marking at all or receive a specific marking showing that these misprints are valueless.

According to the present invention, it is not necessary to read the first identity marking imprinted on a security paper for determining the second and following identity markings. Nevertheless, it is advisable that after achievement of the complete composite identity markings on a set of security papers, the latter is led to a checking device verifying the correct achievement of the hole composite identity markings. This quality control may be understood as a first authenticating test.

After complete identity marking of the sheets of security papers, the same are cut along in rows and columns, so as to form sequential series of isolated security papers. Control signals of the processing unit are distributed to the marking devices of the marking stations so that the sequence of isolated security papers corresponds to the sequence of the alphanumerical identity markings. The misprints are skipped from the sequential series of security papers and thereafter the security papers may be stapled and bundled, the papers of a bundle bearing a continuous sequence of alphanumerical identity marking.

An example of achievement of the process according to the invention will be described now with reference to the enclosed drawing, which shows:

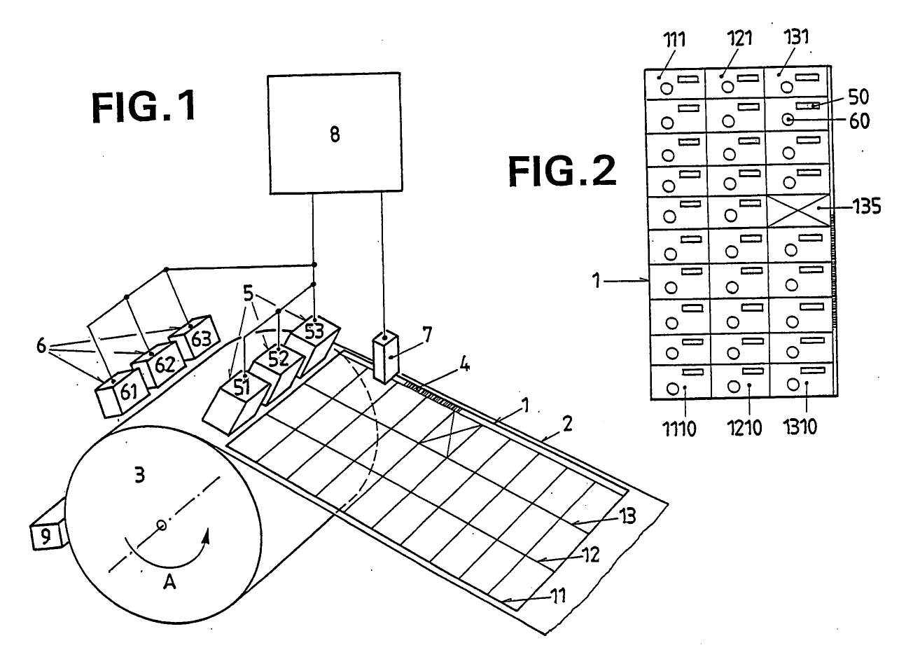

FIG. 1, a schematic and partial representation of a numbering machine for numbering banknotes and

FIG. 2, a simplified and schematic representation of a sheet with banknotes in the state at the issue of the numbering machine of FIG. 1.

It is known to sequentially number notes assembled in sheet and issuing from a printing machine wherein a base design of the notes is identically printed on all the fields of the sheet, these fields corresponding each to a single note in such a way that after cutting the sheets into single notes and stapling, stacks of sequentially numbered notes are formed. It is also known to eliminate automatically misprints during the processing. Particular achievements of such a process are described more particularly in U.S. Pat. No. 5,590,507 assigned to the same Applicant, the content of which is herewith incorporated into the present description.

Now as shown in FIG. 1 of the enclosed drawing, a sheet 1 is placed on a feeding table 2 and guided towards a drum 3 driven in rotation according to the arrow A and leading the sheet 1 towards the operating zones of a plurality of marking devices as will be described later.

Sheet 1 is divided into a plurality of distinct fields, arranged in rows and columns, each field being intended to form a note. In the example represented in FIGS. 1 and 2, sheet 1 comprises three columns 11, 12, 13 and ten rows 1 to 10, each field having, on FIG. 2, a reference numeral [column, row] 111 to 1310. During a previous step where identical base designs have been printed on all its fields, sheet 1 was affected by a misprint which reached on column 13, row 5, that is to say field 135 as it appears from FIG. 1. This misprint has been detected at the output of the printing machine and the information transmitted to a device (not shown) which printed on the length margin of sheet 1 a guide mark 4 in the form of a code bar. Block 7, on FIG. 1 is a reading apparatus, which detects the code bar inscribed on sheets 1.

The numbering machine shown in FIG. 1 comprises a pair of marking stations 5 and 6, disposed at the periphery of drum 3, spaced around the drum. Each station comprises three similar component marking devices 51, 52, 53 and 61, 62, 63 respectively localised each in front of one of the columns 11, 12, 13. While the components 5 work according to the technology of mechanical typography, components 6 can work according to another technology, e.g. ink jet technology, laser marking technology, embossment technology, or other. The number of the different marking stations could also be higher than two. The components of the station 5 with mechanical typography could be arranged as taught by U.S. Pat. No. 5,660,106, for example. Mechanical numbering boxes could also be used.

Advantages of mechanical typography are magnetic and/or IR security as well as high resolution and slight embossing. On the other hand there is lack of flexibility in terms of fonts and data.

Ink jet technology does not provide such a high resolution and magnetic security inks cannot be used for technical reason. However, this technology provides high flexibility in terms of fonts and change of jobs.

Laser marking technology can mark with very high resolution and get high flexibility.

Reader 7 is connected to a processing unit 8 arranged for sending control signals to all the components 51, 52, 53, 61 62, 63 of the different marking stations. Components 51 and 61 act on the fields of col.11, components 52 and 62 on the fields of col.12 and components 53 and 63 on the fields of col.13. Thus the components 5 print a serial number on the notes and components 6 provide at a different location of the note a second partial identity marking linked to the particular serial number of the note.

As shown on FIG. 1, the field 135 of sheet 1 was a misprint and when reading the code bar 4, reader 7 detected the location of this misprint, and transmitted the data to the processing unit, which stores these data in a transient data base so that when sequentially control signals are sent to the marking devices 5 and 6, for sequentially determining the partial identity markings to be achieved on the different notes of sheet 1, processing unit orders 8 to omit field 135.

The correlation between the different fields of sheet 1 and the sequence of operations of the marking devices components 51 to 63 should not necessarily be established by co-operation of a code bar and a reader, like elements 4 and 7 which are provided in FIG. 1 in connection with detection of the misprints. Other correlation means between the function of the marking devices components and the location of the fields in sheet 1 could also be realised. In any case an element in the programmation of the transient database will play a function similar to that of guide marking 4 according to the pattern effectively present.

FIG. 2 shows the appearance of sheet 1 after having been handled by the numbering machine. Each field 111 to 1310 with the exception of field 135 is provided with a complete identity marking sequentially determining the note. Partial markings 50 are serial number and partial markings 60 are, for example, machine readable image information or figures linked to the serial number. Field 135 is not provided with identity markings so that after cutting and separating the misprints, the valuable notes have continuous serial number.

When leaving drum 3, sheet 1 is led to pass in front of a checking device 9, which verify that the identity markings have been correctly provided.

The further stapling, cutting and bundling operations may be performed as taught by U.S. Pat. No. 5,590,507.

Those skilled in the art will understand that the components 51, 52, 53 of the marking station 5 and the components 61, 62, 63 of the marking station 6 could be located on different drums, e.g. on distinct machines. The processing unit 8 is then connected to both machines and transfers data from one machine to the other upon using the mark 4.

1-16. (canceled)

17. A process for providing composite identity markings on security papers, wherein each composite identity marking comprises a first sequentially distributed alphanumerical identity marking and at least one second identity marking, wherein said first and said at least one second identity markings are linked by a determining rule, wherein said first identity marking is provided by a first marking station and wherein said second identity marking is provided by a second marking station, wherein sets of said security papers are brought successively into marking relationship with said first and second marking stations, wherein said first and second marking stations are controlled by a common processing unit using an authenticating database, said authenticating database associating to each said first alphanumerical identity marking one said at least one second identity marking, wherein said processing unit issues sequentially ordered controlled signals to said first and second marking stations, such that each of said stations achieves on each of the security papers sequentially determined markings, able to form with the markings achieved on the same security paper by the other station(s) a composite marking, and wherein said at least one second marking and said first marking correspond together by virtue of said rule.

18. A process according to claim 17, wherein said first and second marking stations make use of different marking techniques.

19. A process according to claim 17, wherein said first and said second identity markings do not share visible identical portions and each said second identity marking is univocally determined by means of said rule or of a sequence of data stored in said authenticating database.

20. A process according to claim 17, wherein said first identity marking in each complete composite identity marking is achieved by means of a mechanical typography process.

21. A process according to claim 20, wherein the other identity markings in each complete composite identity marking are achieved by a process selected from the group consisting of laser marking processes, inkjet processes, typographic processes and embossment processes.

22. A process according to claim 17, wherein the said sets of security papers are assemblies in form of sheets where the individual security papers occupy adjacent fields distributed in rows and columns, wherein each marking station comprises a plurality of component marking devices, wherein the operating zone of each marking device corresponds to one column, and wherein the control signals emitted by the processing unit are distributed to the different component marking devices, the signals received by each component marking device being sequentially elaborated by means of the authenticating data base in function of the location of the component marking device.

23. A process according to claim 22, wherein the fields of each sheet after having been imprinted to form a base design of the security papers, are checked for misprints and the locations of the fields having misprints are recorded, wherein a guiding mark is associated to each sheet and to a record of the misprints of said sheet so as to form a transient data base, wherein said transient data base is combined to said authenticating data base, so that the control signals emitted by the processing unit skip achievement of an identity marking by all components of the marking devices on those fields where misprints of the base design have been checked.

24. A process according to claim 17, wherein after achievement of the complete composite identity markings on a said set of security papers, the latter is led to a checking device verifying the achievement of the identity markings.

25. A process according to claim 22, wherein said sheets after complete identity marking are cut in rows and columns, are processed to form sequential series of isolated security papers, and wherein said control signals of the processing unit are distributed to the marking devices of the marking stations so that said sequence of isolated security papers corresponds to the sequence of said alphanumerical identity markings.

26. A process according to claim 25, wherein misprints are skipped from said sequential series and thereafter said series of security papers are stapled and bundled.

27. An apparatus for providing composite identity markings on security papers, wherein each composite identity marking comprises a first sequentially distributed alphanumerical identity marking and at least one second identity marking linked by a determining rule, comprising a first marking station and at least a second marking station, wherein said first and second marking stations are connected to and controlled by a common processing unit using an authenticating database, said authenticating database associating to each said first alphanumerical identity marking one said second identity marking, wherein said processing unit has means for issuing sequentially ordered control signals to said first and second marking stations, such that each of said stations achieves on each of the security papers sequentially determined markings, able to form with the markings achieved on the same security paper by the other station(s) a composite marking, wherein said at least one second marking of each security paper and said first marking correspond together by virtue of said rule.

28. An apparatus according to claim 27, wherein said first and second marking stations make use of different marking techniques.

29. An apparatus according to claim 27, wherein the marking stations are selected from the group consisting of laser marking, inkjet, typography and embossment stations.

30. An apparatus according to claim 27 for processing sets of security papers assembled in form of sheets where the individual security papers occupy adjacent fields distributed in rows and columns, wherein each marking station comprises a plurality of component marking devices, wherein the operating zone of each marking device corresponds to one column, and wherein the processing unit is programmed so that control signals are distributed to the different component marking devices, the signals received by each component marking device being sequentially elaborated by means of the authenticating data base in function of the location of the component marking device.

31. An apparatus according to claim 30, comprising means to record the misprints of each sheet so as to form a transient data base, wherein the processing unit is capable to combine said transient data base to said authenticating data base, so that the control signals emitted by the processing unit skip achievement of an identity marking by all components of the marking devices on those fields where misprints of the base design have been checked.

32. An apparatus according to claim 27, further comprising a checking device verifying the achievement of the composite identity markings.
